(19) United States
(12) Patent Application Publication
(10) Pub. No.: US 2026/0274715 A1
(43) Pub. Date: Sep. 17, 2026

(54) SYSTEMS AND METHODS OF DRAW SOLUTION RECOVERY WITH ENERGY SAVING EVAPORATION SUPPORTING FORWARD OSMOSIS MEMBRANE CRYSTALLIZATION

(71) Applicant: Fluid Technology Solutions (FTS), Inc., Albany, OR (US)

(72) Inventors: John R. Herron, Corvallis, OR (US); Keith A. Lampi, Albany, OR (US); Edward Gerard Beaudry, Albany, OR (US)

(21) Appl. No.: 19/166,781

(22) PCT Filed: Mar. 19, 2024
(86) PCT No.: PCT/US2024/020562

§ 371 Date: Sep. 18, 2025

Related U.S. Application Data
(60) Provisional application No. 63/491,802, filed on Mar. 23, 2023.
(60) Provisional application No. 63/625,045, filed on Jan. 25, 2024.

(51) Int. Cl. C02F 1/44; B01D 61/00; B01D 61/02; C02F 1/14; C02F 103/08

(52) U.S. Cl. CPC C02F 1/441; B01D 61/002; B01D 61/025; B01D 61/027; C02F 1/14; C02F 1/442; C02F 1/445; B01D 2311/2643; B01D 2313/367; C02F 2103/08

(57) ABSTRACT

Systems and methods for processing seawater, other brine sources, and/or mixed brine, to extract high purity sodium chloride and various sparingly soluble salts are disclosed. Example systems and methods may include (1) feeding the brine stream and one or more antiscalants into various combinations of nanofiltration, reverse osmosis, and osmotically assisted reverse osmosis filters to separate and concentrate the different constituents of the brine stream; (2) incorporating forward osmosis membrane crystallizers to extract and crystalize the concentrated salts; and (3) using high steam economy evaporators, brine cooling towers, solar evaporator, or osmotically assisted reverse osmosis to concentrate the draw streams of the membrane crystallizers. This system provides a significant cost advantage over existing operations as well as providing high purity NaCl crystals.

### CROSS-REFERENCE TO RELATED APPLICATIONS

This application claims priority to U.S. Provisional Patent Application No. 63/491,802 “FORWARD OSMOSIS MEMBRANE CRYSTALLIZATION IN CONJUNCTION WITH OSMOTICALLY ASSISTED REVERSE OSMOSIS AND ANTISCALANTS” filed on Mar. 23, 2023 and U.S. Provisional Patent Application No. 63/625,045 “DRAW SOLUTION RECOVERY WITH MULTI EFFECT EVAPORATORS SUPPORTING FORWARD OSMOSIS MEMBRANE CRYSTALLIZATION IN CONJUNCTION WITH OSMOTICALLY ASSISTED REVERSE OSMOSIS AND ANTISCALANTS” filed on Jan. 25, 2024, the disclosure of each of which are incorporated herein, in its entirety, by this reference.

### BACKGROUND

There is considerable interest in membrane crystallization for selectively removing salts from mixed salt brines. One membrane method which has successfully crystallized salts from brines is described in U.S. Patent Application Pub. No. US 2014/0001122 A1 (the Dead Sea application).

In this system, a first brine, which is at saturation of a particular salt, is contacted to the outside of a vertically oriented forward osmosis membrane plate or series of plates in a tank. A second brine with a higher osmotic pressure is passed through the interior of the plate causing water to pass by osmosis from the first brine through the semipermeable membrane into the second brine. Removal of water from the first brine leads to salt crystals forming on the surface of the membrane. Eventually the growth of salt crystals impedes water transport. At this point the flow of the second brine is stopped and the rapid dilution of the second brine near the membrane causes osmosis to stop. The cessation of water flux causes the salt crystals on the membrane surface to detach and drop by gravity to the bottom of the tank.

This method allows salts to be harvested in sequence from a mixed salt brine.

The use of forward osmosis membrane crystallization (FOMC) described in the Dead Sea application is to assist evaporative crystallization of salts from the Dead Sea. Currently, saturated brine from the Dead Sea is introduced to a series of evaporation ponds where different salts are crystallized. Remaining at the final stage is a brine of primarily MgCl₂ at a concentration above 40% salt. Without the membrane crystallizer, the existing process returns this brine to the Dead Sea. To get more production of salts from the existing brine ponds, the incoming brine from the Dead Sea may be contacted to the outside of forward osmosis membrane plates and the highly concentrated MgCl₂ brine may be contacted to the inside of the plates. The MgCl₂ brine diluted in the process could then be returned to the Dead Sea and the total salt productivity of the site increased.

Osmotically assisted reverse osmosis (OARO) is a membrane technique for concentrating brines to higher salinities than that achievable by reverse osmosis (RO). The process uses osmosis to assist RO by providing salt to the permeate side of a RO membrane. This allows water to be squeezed from a brine which has an osmotic pressure higher than the applied pressure. The salinity on the permeate side of the membrane can be provided either by pumping a brine on the permeate side of the membrane or by letting salt leak through the membrane from the feed brine. The salt-leaking version of the process is discussed in patent application US2015/0014248A1. OARO is successful in concentrating seawater-based brines to salinities of 250 g/L TDS with far less energy than evaporative techniques.

For many brines, membrane concentration is limited by the precipitation of minor, sparingly soluble, species. As an example, seawater concentrated to above 70,000 total dissolved solids (TDS) can have calcium sulfate precipitation on the membrane. Antiscalants have been developed to prevent scaling on membranes during concentration up to levels much higher than saturation. Antiscalants are chemicals which, even in very low dosages, interfere with the formation of crystals. Often concentrations of minor species several times higher than saturation can be safely achieved during membrane concentration.

Antiscalants have a limited range of effectiveness. At some point, well above the normal saturation level, scaling will commence. When this point is reached, the presence of crystals will overcome the crystal suppression of the antiscalant and crystals form. After crystal formation starts, the concentrations of the salts in solution drop to near that predicted for the solution without antiscalant.

Evaporators are commercially used to remove a portion of the water content contained in a brine solution. In a typical single effect evaporator system, steam is used to transfer energy to the brine solution in a chamber, producing water vapor from the brine solution and concentrating the brine. The water vapor from the brine is vented out of the system. To increase efficiency, the system can incorporate more than one evaporation chamber where, instead of steam, the water vapor produced in the first chamber is fed into a subsequent second chamber. Energy from the water vapor from the first chamber is then transferred to the brine solution in the second chamber by condensation of the vapor on a heat exchanger. The second chamber is held at a lower pressure such that the heat transferred causes vaporization in the second chamber, thereby concentrating the brine in that chamber. The water vapor produced in the second chamber can then be fed into yet another evaporator. This is known as a multiple effect evaporator or multi-effect evaporator.

The economy of the single effect evaporator verses multiple effect evaporator is as follows:

$$Evaporator Economy = ( Total Mass of Vapor ) / ( Total Mass of Steam ) \\ Single Effect Evaporator Economy = ( N units of Vapor ) / ( N units of Steam ) = 1 \\ Multiple Effect Evaporator Economy = ( N units of Vapor ) / ( 1 unit of Steam ) = N$$

Thus, the economy of a multiple effect evaporator is N times the economy of a single effect evaporator, producing significant energy savings. The multiple effect evaporator is considered a high steam economy evaporator.

An alternative high steam economy evaporator uses mechanical vapor recompression (MVR). In the MVR process, the vapor from the heated brine is mechanically compressed. The compressed vapor is then condensed on a heat exchanger which transfers heat to the brine causing further vaporization. The system has high steam economy because the energy needed to evaporate water from the brine is recaptured by the condensation of the vapor itself.

Improved steam economy evaporation can also be accomplished by thermal vapor recompression (TVR). This is similar to MVR except the vapor is recompressed by steam jets rather than mechanically.

Multiple effect evaporators may be combined with mechanical vapor recompression or thermal vapor recompression to further improve steam economy.

Another highly energy efficient method of evaporation is the use of waste heat. Many industrial processes generate large amounts of waste heat which is typically removed by cooling towers. Concentration of salt brines by cooling towers saves both energy and water, but it is rarely used because sparingly soluble salts present in most brines cause “salting-up” of the cooling tower. The build-up of salts reduces the performance of the tower and can lead to its collapse.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a block diagram of a system of forward osmosis membrane crystallization and high steam economy evaporation configured to crystalize sodium chloride to a high level of purity, according to an embodiment.

FIG. 2 is a block diagram of a system of filtration stages and forward osmosis membrane crystallization configured to produce the OARO concentrate from the NF permeate stream flowing into the forward osmosis membrane pre-concentrator of FIG. 1 and to produce sparingly soluble salt crystals using forward osmosis membrane crystallization, according to an embodiment.

### DETAILED DESCRIPTION

Described herein are systems and methods using one or more forward osmosis membrane crystallizers to provide high purity sodium chloride from sea water, other potential brine sources, and/or mixed brine, while minimizing energy usage. Additionally, one or more forward osmosis membrane crystallizers are used to remove sparingly soluble salts, such as calcium sulfate, during filtration of the sea water or other sources of brine. Purity levels for sodium chloride of around 99%, and potentially and preferably 99.6% or higher, by weight can be achieved using various combinations of nanofiltration (NF), reverse osmosis (RO), and osmotically assisted reverse osmosis (OARO) to separate and concentrate the different constituents of a brine; incorporating a forward osmosis membrane crystallizer (FOMC) to remove a substantial portion (e.g., around 80% or more) of the sodium chloride out of the nanofiltration system permeate brine stream during seawater processing; and using at least one of one or more high steam economy evaporators, one or more brine cooling towers, one or more solar evaporators, or other sources of industrial waste heat and/or solar energy to reconcentrate the draw solution of the FOMC. This combination of high purity and high economy provides a significant cost advantage over existing operations as well as providing higher purity NaCl crystals.

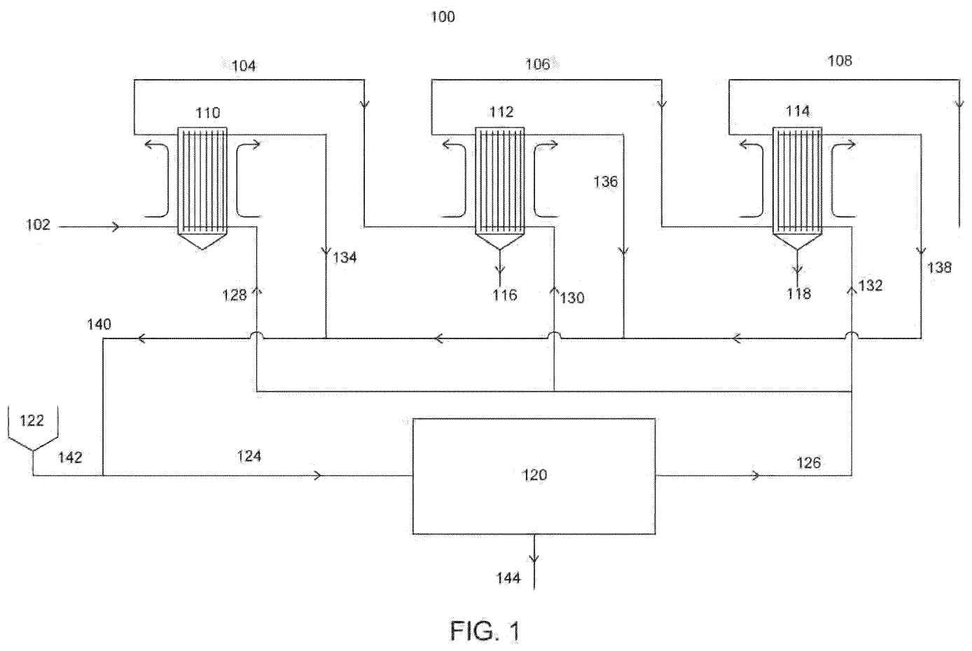

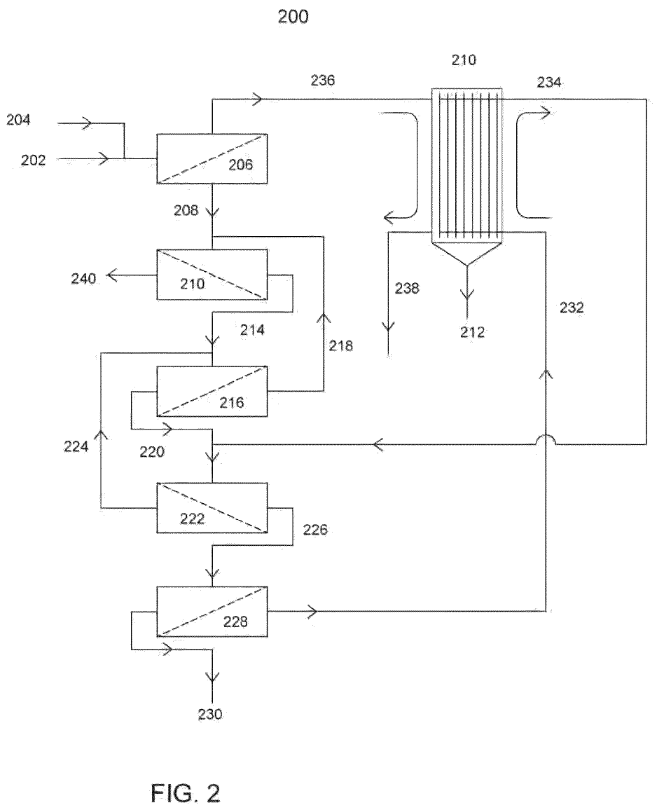

One embodiment of the sodium chloride crystallizer portion of a system 100 is shown for seawater processing in FIG. 1. A high TDS brine 102, also known as the supersaturated solution, the monovalent rich permeate stream, multivalent ion depleted, highly concentrated monovalent mixed brine solution, or the OARO concentrate from NF permeate stream is provided. The high TDS brine 102 comprises predominantly dissolved sodium chloride and potassium chloride salts, that may come from the OARO concentrate from NF permeate brine stream of the membrane separation and filtration portion of the system 200 of FIG. 2. The high TDS brine 102 may exhibit a total dissolved solids (TDS) of about 200,000 mg/L TDS to about 300,000 gm/L TDS (e.g., about 250,000 mg/L TDS). The brine 102 flows into the forward osmosis membrane pre-concentrator 110 which includes a draw solution 128 with a high osmotic potential and may be highly concentrated. The draw solution 128 pulls water from the brine stream 102 and further concentrates the sodium and potassium. The retentate brine stream 104, nearly saturated in sodium chloride, then enters the first forward osmosis membrane crystallizer 112 and the draw solution 130 pulls water from the brine stream 104, further concentrating the sodium and potassium. At this point, the sodium chloride concentration exceeds saturation and comes out of solution. Around 80% or more of crystallized sodium chloride 116 from this system 100 comes out of a first forward osmosis membrane crystallizer 112. The potassium is not yet at a high enough concentration to come out of solution, resulting in a high sodium chloride purity level produced from the first forward osmosis membrane crystallizer 112. The purity of these crystals is higher than those produced from the Dead Sea application because virtually all sparingly soluble salts in stream 104 are removed in upstream filtration. The retentate brine stream 106 from the first forward osmosis membrane crystallizer 112 then flows into a second forward osmosis membrane crystallizer 114. A draw solution 132 on the permeate side of the forward osmosis membrane removes water from the brine stream 106 such that both the sodium and potassium exceed saturation levels and come out of solution as sodium chloride and potassium chloride crystals 118. Around 20% or less of the crystallized sodium chloride from this system comes out of the second crystallizer 114. The retentate brine stream 108 is saturated or nearly saturated in sodium chloride and potassium chloride, and may have elevated levels of other species, such as lithium chloride and/or magnesium chloride and/or boron and/or silica, for example, and may be further processed.

The purity of sodium chloride crystals formed in the first forward osmosis membrane crystallizer 112 is higher than that produced by evaporative crystallizers because the formation is slow and there is no localized over-drying of the solution. Purities of 99.6% or greater by weight of the sodium chloride can be produced.

The draw solution 128 for a forward osmosis membrane pre-concentrator 110, the draw solution 130 for the first forward osmosis brine crystallizer 112, and the draw solution 132 for the second forward osmosis brine crystallizer 114 get diluted when pulling water from the sodium chloride and potassium chloride brine stream and are output as diluted draw solution 134, diluted draw solution 136, and diluted draw solution 138, respectfully. Draw solutions 134, 136, and 138 can be joined together to form a combined diluted draw solution 140. The combined diluted draw solution 140 feeds into the input draw solution 124 of the evaporator 120. Also feeding into the input draw solution 124 may be a draw solution 142 from a container 122 that is used to initially prime the system with a draw solution and to replace any draw solution lost during operations. In normal continuous operation, after priming the system and initial start-up, input draw solution 124 may have the same or similar concentration as the combined diluted draw solution 140. To concentrate/reconcentrate the input draw solution 124, a high steam economy evaporator 120, such as multiple effect evaporation (MEE), mechanical vapor recompression (MVR), or thermal vapor recompression (TVR) is used in this embodiment to remove water 144 from the input draw solution 124. The draw solutions (e.g., one or more of solutions 134, 136, 138, 140, or 124) may also be reconcentrated by use of waste heat in a brine cooling tower. The lack of sparingly soluble salts in the draw solutions prevents salting up of the towers. Various other approaches to using waste heat and/or solar energy to aid in concentrating/reconcentrating the diluted FOMC draw solution stream (e.g., one or more of diluted draw solution 134, diluted draw solution 136, diluted draw solution 138, or combined diluted draw solution 140) may be employed to lessen overall energy consumption. The evaporator 120 may be of various configurations. Such configurations, for example, may include a MEE with forward feed configuration, backward feed configuration, mixed feed configuration, or parallel feed configuration. The MEE will run at about 3-5 times less energy than traditional thermal non-membrane crystallizers. Other evaporators such as MVR or TVR can also be used and result in decreased energy usage compared to a traditional, non-membrane, thermal crystallizer. Evaporation may also be performed with waste heat in a cooling tower.

Depending on geography, the reconcentration of one or more of the draw solutions disclosed herein could also be achieved using solar evaporators (e.g., solar evaporation ponds). Various other approaches to using waste heat and/or solar energy to aid in concentrating/reconcentrating the diluted FOMC draw solution stream may be employed to lessen overall energy consumption.

Magnesium chloride is an effective draw solution for the system 100. This is due to the high osmotic potential and the availability of magnesium chloride as a component of the mixed brine stream 202 (e.g., seawater) initially input into the overall system 200 of FIG. 2. Magnesium chloride may be extracted from retentate stream 236 (i.e., divalent ion rich stream) or more preferably stream 238, produced in this process. The draw solution 126 has a higher salinity (e.g., about 30% to about 40% magnesium chloride, about 35% to about 45% magnesium chloride, about 40% to about 50% magnesium chloride, about 45% to about 55% magnesium chloride, or about 50% to about 60% magnesium chloride), while depleted draw solution 140 has a lower salinity (e.g., about 15% to about 25% magnesium chloride, about 20% to about 30% magnesium chloride, about 25% to about 35% magnesium chloride, about 30% to about 40% magnesium chloride, about 35% to about 45% magnesium chloride, or about 40% to about 50% magnesium chloride). Other osmotically appropriate draw solutions may be used.

FIG. 2 shows the rest of the overall system 200 including the origin 230 of the high TDS brine 102 flowing into the forward osmosis membrane pre-concentrator 110 in FIG. 1. This embodiment shows the use of FOMC to produce sparingly soluble salt crystals.

The input 202 of system 200 is a brine stream (e.g., mixed brine stream), such as but not limited to seawater, which contains both monovalent and multivalent ions. The input brine stream 202 is combined with antiscalants 204 and is processed to separate the multivalent ions into the retentate stream 236 (a.k.a, multivalent ions) and the monovalent ions into the permeate stream 208 (a.k.a., monovalent ions) using nanofiltration membranes 206. The nanofiltered permeate stream 208 may be pressurized to high pressure (e.g., about 60 bar or more) and is concentrated using a series of RO 210 and OARO stages 216, 222, and 228 to produce the monovalent rich brine stream concentration 230, for example at 250,000 mg/L TDS. The retentate 214 from RO filter 210 is passed to OARO filter 216. The retentate 220 from OARO filter 216 is passed to OARO filter 222. The retentate 226 from OARO filter 222 is passed to OARO filter 228. The retentate from OARO filter 228 is the OARO concentrate 230. The above is an example of a system configuration for creating concentrated salt brines from seawater. It is understood that other system configurations are possible and contemplated.

The permeate 240 from the RO system 210 is high purity water for use or discharge.

The permeate 218 from OARO filter 216 has a salinity similar to permeate stream 208. The permeate 218 is pressurized and combined with the permeate stream 208 to feed into OARO filter 210.

The permeate 224 from OARO filter 222 has a similar salinity to the retentate 214 from RO filter 210. The permeate 224 is pressurized and combined with the retentate 214 and fed into OARO filter 216.

The permeate 232 from OARO filter 228 is the draw solution fed to the forward osmosis membrane crystallizer 210.

The dilute draw solution 234 from the forward osmosis membrane crystallizer 210 has salinity similar to the retentate 220 from OARO filter 216. The dilute draw solution 234 is pressurized and combined with retentate 220 to provide the feed into OARO filter 222.

Adding antiscalants 204 to the brine input 202 of the nanofiltration system 206 allows concentration of sparingly soluble salts in the retentate 236 of nanofiltration filter 206 to concentrations far more than saturation. While FIG. 2 shows use of a nanofiltration membrane to concentrate sparingly soluble salts, other filters such as RO or OARO may provide a retentate with sparingly soluble salts far above saturation.

The retentate 236 from the nanofiltration membrane 206 may have a concentration of sparingly soluble salts several times higher than its saturation level (e.g., at least about 25% above saturation level, at least about 50% above saturation level, at least about 75% above saturation level, at least about 100% above saturation level, at least about 150% above saturation level, at least about 200% above saturation level, at least about 300% above saturation level, at least about 400% above saturation level, or at least about 500% above saturation level) and is kept in solution by antiscalants. Water removal from the retentate stream 236 in the crystallizer 210 causes the sparing soluble salts to crystalize on the membrane of the crystallizer 210. The presence of salt crystals on the membrane reduces the effectiveness of the antiscalants allowing crystals to grow until the solution concentration falls to near the saturation level.

Crystals formed on the membrane can be intermittently removed by interrupting permeate 232 (i.e., draw solution) thereby inducing the salt crystals to drop off the membrane by gravity and fall to the bottom of the crystallizer 210 as output 212.

The retentate 238 can be filtered after crystallization and with the addition of more antiscalants, can be further concentrated with OARO (not shown).

In one embodiment, as discussed above and as shown, the high salinity brine that is used as the draw solution in the FOMC process is the permeate 232 from OARO 228.

In another embodiment, not shown, the high salinity brine needed as the draw solution in the FOMC process is at least partially produced using at least one evaporator, such as a high steam economy evaporator (not shown).

Filters 206, 210, 216, 222, and 228 may contain multiple filter elements. FOMC crystallizers and pre-crystallizers 110, 112, 118, and 210 may contain multiple filter elements.

As an example, the above nanofiltration retentate concentration system was mathematically modelled at certain operation parameters (e.g. pressures, pumps, element configurations, etc.). One set of modeling conditions yields the following concentrations assuming a seawater feed of 47,000 mg/L TDS. This is the same TDS level from a sample taken from the Red Sea.

The major ionic species in seawater in the Red Sea are shown in the second column of Table 1.

Referring to FIG. 2, antiscalants are added to the seawater and NF is performed until a recovery of around 87% is achieved. The reject (e.g., the retentate 236) is around 13% of the feed volume and is calculated to have the chemistry shown in column 3 of Table 1. This NF retentate is approximately 4 times the equilibrium saturated concentration for CaSO₄.

The permeate is modelled to be concentrated to a salinity of about 250,000 mg/L TDS by a combination RO/OARO as shown in FIG. 2. The modelled chemistry of the concentrated permeate is shown in column 5 of Table 1. The OARO is assumed to be the type which provides salt to the permeate by allowing leakage from the feed.

The reject from the nanofiltration is added to an FOMC system where around 25% of the volume would be removed by forward osmosis. Water removal overcomes the effectiveness of the antiscalants and once crystallization is initiated, calcium sulfate crystallizes on the membrane surface dropping the solution concentration back to near equilibrium concentration. The calculated chemistry of the brine leaving the FOMC is shown in column 6 of Table 1. This solution can be further concentrated to 250,000 TDS by an OARO process after the addition of antiscalants.

A block diagram of one embodiment of the calcium sulfate crystallization system is shown in FIG. 2. The highly concentrated osmotic draw solution 232 is the permeate produced by the last stages of the OARO process, specifically OARO filter(s) 228 in this example. Diluted draw solution is fed back into the OARO system and/or back into the evaporator system.

Alternatively, or in combination with utilizing the permeate produced by the last stages of the OARO system, evaporators, brine cooling towers, other sources of industrial waste energy, and/or solar evaporation may be used to produce the highly concentrated osmotic draw solution (not shown).

TABLE 1
TDS in mg/L of streams during the concentration of Red Sea water

| | | | | OARO | FOMC |
|---|---|---|---|---|---|
| | | | | concentrate | out of |
| | Raw | NF | NF | from NF | CaSO₄ |
| | Seawater | retentate | permeate | permeate | concentrator |
| Ca⁺⁺ | 520 | 3,000 | 180 | 1125 | 920 |
| Ba⁺⁺ | 0.07 | 0.4 | 0.02 | 0.12 | 0 |
| Mg⁺⁺ | 1,600 | 12,000 | 175 | 1,100 | 15,000 |
| K⁺ | 760 | 750 | 760 | 4,750 | 940 |
| Na⁺ | 14,500 | 14,400 | 14,500 | 90,600 | 18,000 |
| Sr⁺⁺ | 10 | 55 | 4 | 30 | 10 |
| Cl⁻ | 26,000 | 41,000 | 24,000 | 150,000 | 51,000 |
| HCO₃⁻ | 144 | 30 | 20 | 130 | 0 |
| CO₃⁻⁻ | 28 | 0 | 0 | 0 | 0 |
| SO₄⁻⁻ | 3,600 | 30,000 | 2 | 12 | 30,800 |
| TDS | 47,000 | 100,000 | 40,000 | 250,000 | 115,000 |

Other calculated values include:
NF permeate 208: 35,000 mg/L TDS
Retentate 214: 70,000 mg/L TDS
Permeate 218: 30,000 mg/L TDS
Retentate 220: 130,000 mg/L TDS
Permeate 224: 100,000 mg/L TDS
Retentate 226: 190,000 mg/L TDS
Retentate 230: 250,000 mg/L TDS
Permeate 232: 170,000 mg/L TDS
Dilute draw solution 234: 150,000 mg/L TDS
Nanofiltration retentate 236: 100,000 mg/L TDS
Concentrate stream 238 from crystallizer 210: 115,000 mg/L TDS

1. A method for crystallizing sparingly soluble salts from mixed brines, the method comprising:
performing membrane concentration or separation on the mixed brines by reverse osmosis, nanofiltration, osmotically assisted reverse osmosis, or any combination thereof to form a supersaturated solution;
using of one or more antiscalants during the membrane concentration or separation such that a concentration of one or more salts is above equilibrium saturation;
introducing the supersaturated solution into a forward osmosis membrane crystallizer having a flow of high osmotic strength draw solution to at least one forward osmosis membrane of the forward osmosis membrane crystallizer; and
concentrating the supersaturated solution in the forward osmosis membrane crystallizer until the one or more antiscalants no longer suppresses crystal formation and crystals form on a surface of the at least one forward osmosis membrane causing the solution concentration to fall to near the equilibrium saturation level creating a slightly oversaturated brine stream output from the forward osmosis membrane crystallizer.

2. The method of claim 1, further comprising halting a flow of the high osmotic strength draw solution to the at least one forward osmosis membrane to allow the crystals formed on the at least one forward osmosis membrane to periodically fall from the at least one forward osmosis membrane.

3. The method of claim 1, further comprising producing the high osmotic strength draw solution by reverse osmosis, osmotically assisted reverse osmosis, or a combination of the two.

4. The method of claim 1, further comprising, after adding of one or more additional antiscalants, further concentrating the slightly oversaturated brine stream output from the crystallizer by reverse osmosis, osmotically assisted reverse osmosis, or a combination thereof.

5. The method of claim 1, further comprising reconcentrating the high osmotic strength draw solution, at least in part, using at least one of high steam economy evaporation, evaporation in a brine cooling tower, or solar evaporation.

6. The method of claim 1, wherein performing membrane concentration or separation includes using nanofiltration, with the one or more antiscalants to separate the mixed brine into a divalent-rich retentate stream and a monovalent-rich permeate stream, the divalent rich retentate stream is concentrated to a point where a concentration of calcium sulfate is several times higher than its equilibrium value, the divalent rich retentate stream is then introduced to the forward osmosis membrane crystallizer, wherein the mixed brine includes seawater.

7. The method of claim 6, wherein performing membrane concentration includes concentrating the monovalent permeate stream using reverse osmosis or osmotically assisted reverse osmosis.

8. The method of claim 7, further comprising producing the high osmotic strength draw solution for the forward osmosis membrane crystallizer by concentrating the monovalent rich permeate stream.

9. The method of claim 1, wherein performing membrane concentration or separation includes, after using the one or more antiscalants, concentrating the mixed brine to exhibit a concentration of calcium sulfate that is several times its equilibrium value.

10. A forward osmosis membrane crystallizer system for crystallizing sparingly soluble salts from a mixed brine, the forward osmosis membrane crystallizer system comprising:
an input for introducing the mixed brine into the system;
at least one of reverse osmosis membrane, nanofiltration membrane, or osmotically assisted reverse osmosis membrane for concentrating or separating the mixed brine;
an input for introducing one or more antiscalants into the system to suppress crystal formation; and
a forward osmosis membrane crystallizer including at least one forward osmosis membrane and an input for receiving a high osmotic strength draw solution on the permeate side of the at least one forward osmosis membrane of the forward osmosis membrane crystallizer, the input configured to provide the high osmotic strength draw solution having an osmotic pressure greater than an osmotic pressure of the mixed brine osmotic pressure; and
wherein the forward osmosis membrane is configured to concentrate one or more of the sparingly soluble salts in the mixed brine so that a concentration of the sparingly soluble salts becomes above equilibrium saturation until the one or more antiscalants no longer suppresses crystal formation and crystals form on a surface of the at least one forward osmosis membrane.

11. The forward osmosis membrane crystallizer system of claim 10, where the input for providing the high osmotic strength draw solution is configured to halt a flow of the high osmotic strength draw solution to the at least one forward osmosis membrane to allow the crystals formed on the at least one forward osmosis membrane to periodically fall from the at least one forward osmosis membrane.

12. The forward osmosis membrane crystallizer system of claim 10, wherein the forward osmosis membrane crystallizer system includes at least one of the reverse osmosis membrane or the osmotically assisted reverse osmosis membrane, and wherein the at least one of the reverse osmosis membrane or the osmotically assisted reverse osmosis membrane is configured to produce the high osmotic strength draw solution.

13. The forward osmosis membrane crystallizer of claim 10, further comprising at least one of one or more high steam economy evaporators, one or more cooling towers, or one or more solar evaporators configured to produce, in part, the high osmotic strength draw solution.

14. The forward osmosis membrane crystallizer system of claim 10, where the forward osmosis membrane crystallizer is configured to crystallize calcium sulfate.

15. A forward osmosis membrane crystallizer system for crystallizing sodium chloride to high purity levels around or above 99.0%, the forward osmosis membrane crystallizer system comprising:
an input for introducing a multivalent ion depleted, highly concentrated monovalent mixed brine stream into the system;
a forward osmosis membrane crystallizer including at least one forward osmosis membrane; and
an input for introducing a highly concentrated draw solution having an osmotic potential greater than the sodium chloride brine osmotic potential into the system;
wherein the forward osmosis membrane is configured to allow the highly concentrated at least one draw solution to remove water from the highly concentrated sodium chloride brine stream to a point where the sodium chloride concentration exceeds saturation and crystalizes on the at least one forward osmosis membrane.

16. The forward osmosis membrane crystallizer system of claim 15, where the system is configured to halt a flow of highly concentrated draw solution to the at least one forward osmosis membrane to allow the crystals formed on the at least one forward osmosis membrane to periodically fall from the at least one forward osmosis membrane.

17. The forward osmosis membrane crystallizer system of claim 15, further comprising at least one of one or more high steam economy evaporators, one or more brine cooling towers, or one or more solar evaporations configured to produce, in part, the highly concentrated draw solution.

18. The forward osmosis membrane crystallizer system of claim 15, where the forward osmosis membrane crystallizer system is configured to crystallize sodium chloride to high purity levels at or above 99.6% pure.

19. The forward osmosis membrane crystallizer system of claim 15, where the draw solution is magnesium chloride.

20. The forward osmosis membrane crystallizer system of claim 15, further comprising a forward osmosis membrane pre-crystallizer configured to concentrate the sodium chloride in the multivalent ion depleted, highly concentrated monovalent mixed brine stream to near saturation before the multivalent ion depleted, highly concentrated monovalent mixed brine stream is further concentrated in the forward osmosis membrane crystallizer.

21. The forward osmosis membrane crystallizer system of claim 15, further comprising an additional forward osmosis membrane crystallizer configured to concentrate a retentate from the multivalent ion depleted, highly concentrated monovalent mixed brine stream generated by the forward osmosis membrane crystallizer, the addition forward osmosis membrane crystallizer configured to form sodium chloride and potassium chloride crystals.

22. A method for crystallizing sodium chloride to high purity levels around or above 99.0%, the method comprising:
introducing a multivalent ion depleted, highly concentrated monovalent mixed brine stream containing sodium chloride into a forward osmosis membrane crystallizer having at least one forward osmosis membrane;
providing a flow of highly concentrated draw solution, having an osmotic potential greater than an osmotic potential of the multivalent ion depleted, highly concentrated monovalent mixed brine stream, to a permeate side of the at least one forward osmosis membrane of the forward osmosis membrane crystallizer thereby removing water from the multivalent ion depleted, highly concentrated monovalent mixed brine stream and into the highly concentrated draw solution;
concentrating the multivalent ion depleted, highly concentrated monovalent mixed brine stream in the forward osmosis membrane crystallizer to a point where a concentration of the sodium chloride exceeds saturation to form crystals on the at least one forward osmosis membrane;
reconcentrating the highly concentrated draw solution; and
removing the crystals from the at least one forward osmosis membrane.

23. The method of claim 22, further comprising periodically halting the flow of the highly concentrated draw solution to the at least one forward osmosis membrane to allow the crystals formed on the forward osmosis membrane to fall from the membrane.

24. The method of claim 22, where reconcentrating the high osmotic strength draw solution occurs at least in part by at least one of one or more high steam economy evaporators, one or more brine cooling towers, or one or more solar evaporators.

25. The method of claim 22, where a concentration of the sodium chloride in the crystals is at or above 99.6% pure.

26. The method of claim 22, where the highly concentrated draw solution includes magnesium chloride.

27. The method of claim 22, where the multivalent ion depleted, highly concentrated monovalent mixed brine stream is processed through a forward osmosis membrane pre-crystallizer to increase a concentration of the sodium chloride closer to saturation before processing in the forward osmosis membrane crystallizer.

28. The method of claim 22, further comprising introducing a retentate from the forward osmosis membrane crystallizer to an additional forward osmosis membrane crystallizer for crystallization and removal of sodium chloride and potassium chloride.
